(19) United States
(12) Patent Application Publication
(10) Pub. No.: US 2025/0381935 A1
(43) Pub. Date: Dec. 18, 2025

(54) PRESSURIZED FLUID SYSTEM FOR CLEANING SENSOR

(71) Applicant: International Truck Intellectual Property Company, LLC, Lisle, IL (US)

(72) Inventors: Peter S. Wong, Naperville, IL (US); Caio Carneiro Poyares dos Reis, Aurora, IL (US); Robert M. Tourville, Warrenville, IL (US)

(73) Assignee: International Truck Intellectual Property Company, LLC, Lisle, IL (US)

(21) Appl. No.: 19/130,445

(22) PCT Filed: Dec. 20, 2022
(86) PCT No.: PCT/US2022/053456

§ 371 Date: May 15, 2025

(51) Int. Cl. B60S 1/56; B60S 1/50; B60S 1/52

(52) U.S. Cl. CPC B60S 1/56; B60S 1/50; B60S 1/52

(57) ABSTRACT

A method for cleaning a sensor surface on a vehicle comprises operating the at least one actuator coupled to at least one nozzle for controlling flow of pressurized cleaning fluid from a pressurized reservoir to flow pressurized cleaning fluid to the at least one spray nozzle, dispensing the pressurized cleaning fluid from the at least one spray nozzle toward the sensor surface, and operating the at least one actuator into a closed position and reducing flow of the pressurized cleaning fluid flowing to the at least one spray nozzle.

### BACKGROUND

The present subject matter relates generally to a vehicle sensor cleaning system and method of using vehicle sensor cleaning system. More specifically, this disclosure relates to a pressurized fluid system, and related methods, that use a spray nozzle, a pressurized reservoir located adjacent the spray nozzle which provides pressurized fluid to the spray nozzle at sufficient pressure and volume without a secondary or booster pump.

In a traditional vehicle washer/wiper system, washer fluid and a wiper work together to clean a contaminant from a sensor surface associated with, for instance, a windshield or a headlamp. The washer fluid is sprayed onto the sensor surface in order to wet the sensor surface and soften the contaminant for removal from the sensor surface. The wiper wipes the sensor surface repeatedly to remove the softened contaminant.

A conventional vehicle sensor cleaning system generally directs a jet of washer fluid onto a sensor surface and then directs compressed air onto the sensor surface for drying the sensor surface. This cleaning system typically utilizes a single pump to feed a spray nozzle. This cleaning system has traditionally included a number of nozzles corresponding to a number of sensors disposed on a vehicle.

Current vehicle technology, particularly with the rise of Advanced Driver Assistance Systems (ADAS) and Automated Driving systems (ADS), incorporates a number and variety of sensors, including camera sensors, LIDAR sensors, and others each having a sensor surface. Each sensor surface is cleaned to reduce dirt and other contaminants from obstructing view of the sensor. Some of these sensors cannot be cleaned with a traditional cleaning system without risking negative performance of the sensor.

Additionally, conventional sensor cleaning systems may not be equipped to provide washer fluid to a number of spray nozzles, as a single pump may not overcome fluid pressure drop resulting from the number of spray nozzles, rendering the cleaning system less performant. For reference, an example of a conventional sensor cleaning system 50 is shown in FIG. 1. As shown, washer fluid is stored in a washer fluid storage 52 remote from a spray nozzle 54. A primary pump 56 directs washer fluid through tubing 57 toward the spray nozzle 54. A secondary pump 58 disposed on the tubing downstream of the primary pump 56 and adjacent the spray nozzle 54 increases pressure within the tubing 57 and directs the washer fluid to a fluid control valve 60, which controls volume and pressure of washer fluid supplied to the spray nozzle 54. The spray nozzle 54 directs a spray of washer fluid 62 onto a sensor surface 64. Once a sufficient amount of washer fluid spray 62 has been sprayed onto the sensor surface 64, a compressed air nozzle 66 directs compressed air 68 onto the sensor surface 64 to expedite drying the sensor surface 62.

To address a number of sensors, conventional cleaning systems include an additional pump to address different spray nozzle 54 locations and/or zones. Operatively connected with the tubing 57, a primary pump 56 is combined with a secondary pump 58 disposed adjacent spray nozzles 54. As shown in FIG. 1, the secondary pump 58 is disposed between the primary pump 54 and the spray nozzles 54 to overcome pressure loss along tubing 57 and to boost fluid pressure near the spray nozzle 54. Use of additional components to the conventional cleaning systems can result in increased maintenance and cleaning system costs.

Accordingly, there is a need for a pressurized cleaning fluid system and related methods that provide pressurized cleaning fluid to a spray nozzle without a secondary pump.

### SUMMARY

An embodiment of a method for cleaning a sensor surface on a vehicle comprises operating the at least one actuator coupled to at least one nozzle for controlling flow of pressurized cleaning fluid from a pressurized reservoir to flow pressurized cleaning fluid to the at least one spray nozzle, dispensing the pressurized cleaning fluid from the at least one spray nozzle toward the sensor surface, and operating the at least one actuator into a closed position and reducing flow of the pressurized cleaning fluid flowing to the at least one spray nozzle.

### BRIEF DESCRIPTION OF THE DRAWINGS

FIG. 1 is a diagram of a prior art vehicle sensor cleaning system; and

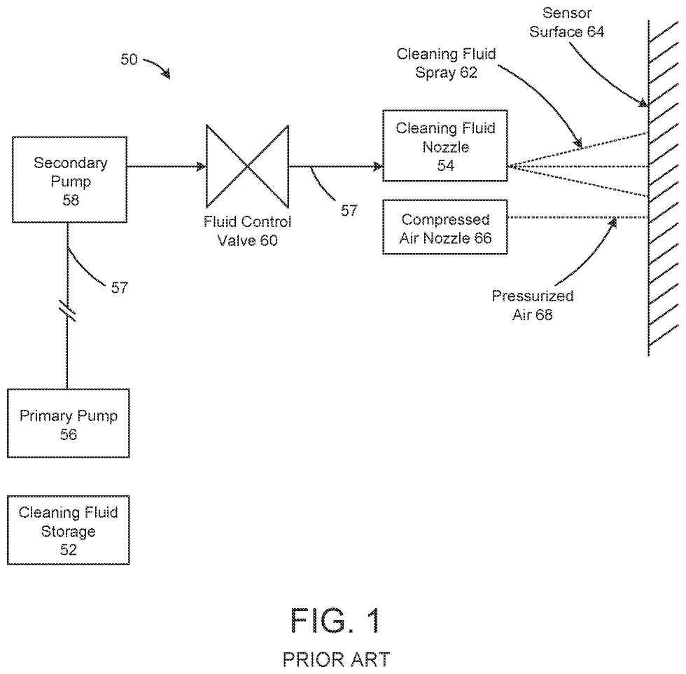

FIG. 2 is a diagram of a vehicle sensor cleaning system including a pressurized reservoir described herein.

### DETAILED DESCRIPTION

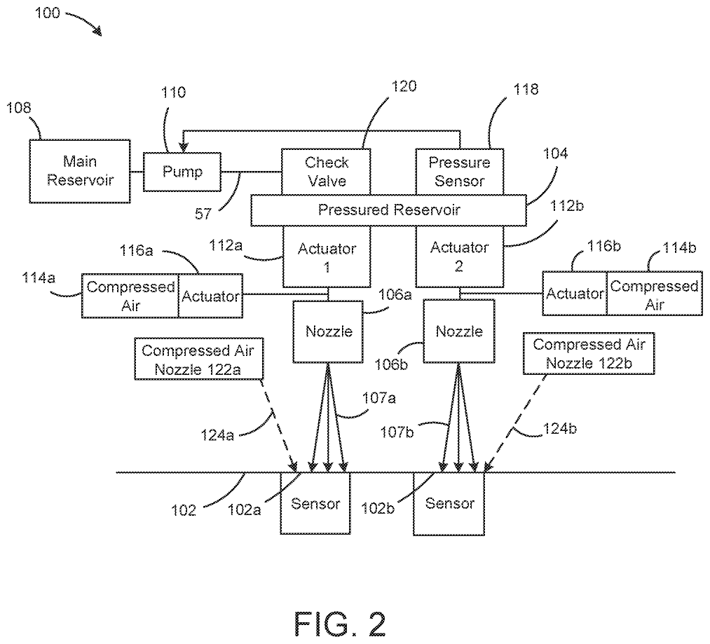

FIG. 2 illustrates a pressurized fluid system 100 for cleaning sensor surfaces 102a, 102b of surface 102. The vehicle sensor cleaning system 100 may be located on any vehicle, such as a truck, a trailer tractor, a bus, an auto and the like. The pressurized fluid system 100 includes a pressurized reservoir 104 located proximal to or near the spray nozzle 106a and nozzle 106b without use of a secondary or booster pump, a common component in conventional vehicle sensor cleaning systems. In the embodiment illustrated in FIG. 2, the pressurized fluid system 100 includes a main reservoir 108, such as a tank or the like, disposed on the vehicle and a pump 110 disposed on the vehicle and located distal from the spray nozzle 106a and the spray nozzle 106b while the pressurized reservoir 104 is disposed on the vehicle and is located proximal to the spray nozzle 106a and the spray nozzle 106b.

As shown in FIG. 2, the pressurized fluid system 100 may include one or more spray nozzles 106. While, in some embodiments, the pressurized fluid system 100 includes only a single spray nozzle 106, the pressurized fluid system 100 may accommodate a plurality of spray nozzles 106 operating for individual or simultaneous cleaning effectively and efficiently. By providing the pressurized reservoir 104 near a plurality of sensor surfaces 102 comprising plurality of spray nozzles 106, the pressurized reservoir 104 enables the pressurized fluid system 100 to operate the plurality of spray nozzles 102 simultaneously to dispense a sufficient volume of pressurized cleaning fluid 107.

Referring to FIG. 2, the pressurized fluid system 100 includes an actuator 112 operatively connected with each spray nozzle 106 connected to the pressurized reservoir 104 to control flow of pressurized cleaning fluid 107 from the pressurized reservoir 104 to the spray nozzle 102 during a cleaning cycle. In some embodiments, the actuator 112 may be a valve. A cleaning cycle begins upon actuation or operation of the actuator 112 into an open position and ends upon actuation or operation of the actuator 112 into a closed position. When an actuator 112 is operated, pressurized cleaning fluid 107 is dispensed from the spray nozzle 106.

In some embodiments, compressed air 114b is added to flow of pressurized cleaning fluid 107 from the spray nozzle 106b to generate a charged pressurized cleaning fluid 107b. As shown in FIG. 2, compressed air 114b is added to the pressurized cleaning fluid 107 between the actuator 112 and the spray nozzle 106b to increase pressure of the cleaning fluid dispensed from the spray nozzle 106b onto the sensor surface 102b. Timing and coordination to pressure charge the pressurized cleaning fluid before reaching the spray nozzle 106b is enabled through use of the actuator 116b associated with the compressed air source 114b and the actuator 112 operatively associated with the pressurized reservoir 104.

The charged pressurized fluid 107b has a pressure greater than pressure of the pressurized reservoir 104. Using the compressed air source 114b, pressure of the charged pressurized cleaning fluid 107b dispensed from the spray nozzle 106b is greater than pressure of the pressurized reservoir 104. Without the use of compressed air 114b, pressure of pressurized cleaning fluid dispensed from the spray nozzle 106b corresponds to pressure of the pressurized reservoir 104.

In some embodiments, compressed air may be added directly to at least one of the actuator 112a and the actuator 112b, tubing 57 through which fluid flows between the actuator 112a and the spray nozzle 106a, the actuator 112b and the spray nozzle 106b. Further, while the illustrated embodiment includes separate source of compressed air 114 for each spray nozzle 106, a single source of compressed air 114 may provide compressed air to a plurality of spray nozzles 106.

If one or more actuators 112 remain in the open position, pressure in the pressurized reservoir 104 as well as pressure of the pressurized cleaning fluid 107 dispensed from a spray nozzle 106 may decrease until pressure in the pressurized reservoir 104 reaches a pressure output of the pump 110 adjacent the main reservoir 108. To increase pressure within the pressurized reservoir 104, at least one actuator 112 is actuated into the closed position as the pump 110 continues to pump fluid into the pressurized reservoir 104.

A pressure sensor 118 disposed on the pressurized reservoir 104 monitors pressure thereof. The pump 110 is in communication with the pressure sensor 118 and is activated and deactivated according to pressure of the pressurized reservoir 104. The pressure sensor 118 includes a pressure sensor controller that stores a cut-on pressure threshold and a shut-off pressure threshold of the pressurized reservoir 104. The pressure sensor 118 activates the pump 110 when pressure of the pressurized reservoir 104 drops below the cut-on pressure threshold and deactivates the pump 110 when pressure of the pressurized reservoir 104 reaches the shut-off pressure threshold.

The cut-on and shut-off pressure thresholds may be based on pressure fluctuation caused by a cleaning cycle of the spray nozzles 106. When the actuator 112 of a spray nozzle 106 is operated, fluid is released from the pressurized reservoir 104 to the spray nozzle 106 and dispensed therefrom, resulting in a decrease in pressure of the pressurized reservoir 104. The pressure in the pressurized reservoir 104 continues to decrease as the spray nozzle 106 continues to dispense fluid during the cleaning cycle.

In one example, the cut-on pressure threshold triggering activation of the pump 110 corresponds to a minimum pressure of the pressurized reservoir 104 for effective cleaning, and the shut-off pressure triggering deactivation of the pump 110 corresponds to a maximum pressure of the pressurized reservoir 104. In another example, the cut-on pressure threshold triggering activation of the pump 110 may correspond to pressure in the pressurized reservoir 104 at an end of a cleaning cycle, and the shut-off pressure threshold triggering deactivation of the pump 110 may correspond to pressure in the pressurized reservoir 104 prior to start of a cleaning cycle. In other examples, the pressurized fluid system 100 operates multiple cleaning cycles of the spray nozzles 106 between reaching the cut-on pressure threshold and the shut-off pressure threshold.

Pressure, including a minimum pressure and a maximum pressure, of the pressurized reservoir 104 is dependent on type of sensor that requires cleaning and specifications of components of the pressurized fluid cleaning system 100, such as but not limited to the spray nozzle(s) 106, the actuator 112, the pump 110, and the pressurized reservoir 104. Distances between the main reservoir 108, the pressurized reservoir 104, and the spray nozzles 106 are dependent on type of sensor that requires cleaning and a system designed around location of the sensor.

The pressurized fluid system 100 enhances cleaning cycle, repeating the cleaning cycle until it is determined that a sensor is sufficiently cleaned or that the sensor cannot be sufficiently cleaned. The cleaning cycle parameters may vary depending on sensor location, sensor type, duration of pressurized cleaning fluid spray, pressurized air duration, and cycle number. For example, the cleaning cycle for a camera located on a roof of a vehicle may have different parameters than the cleaning cycle for a radar sensor located in the vehicle bumper, or parameters for a first cleaning cycle attempt may be different than a third cleaning cycle for one sensor.

In some embodiments, a check valve 120 is disposed on the tubing 57 at the pressurized reservoir 104 to reduce backflow of the pressurized cleaning fluid 107 toward the pump 110.

Further, the actuator 112 may be actuated using any appropriate method, such as electric method, pneumatic method, hydraulic method and any combination of those methods. The pressurized fluid system 100 may also include sensors and/or timers for triggering the actuator(s) based on an amount of debris detected on a sensor surface 102, a regular cleaning frequency of a sensor surface 102, manual operation, or any other suitable condition.

In some embodiments, a compressed air nozzle 122a and compressed air nozzle 122b direct compressed air 124a and compressed air 124b, respectively, onto the sensor surface 102a and sensor surface 102b after a sufficient amount of pressurized cleaning fluid 107a and pressurized cleaning fluid 107b has been sprayed thereon in order to expedite drying the sensor surface 102a and sensor surface 102b. While the illustrated embodiment includes a compressed air nozzle 122a for spray nozzle 106a and a compressed air nozzle 122b for spray nozzle 106b, one or more compressed air nozzles 122 may be used as needed or desired for any number of spray nozzles 106.

A method of using the pressurized fluid system 100 will now be described. A pressurized fluid system 100 including a main reservoir 108, a pressurized reservoir 104 located distal from the main reservoir 108, a pump 110 fluidly or pneumatically connected to the main reservoir 108 for directing pressurized cleaning fluid 107 from the main reservoir 108 to the pressurized reservoir 104, at least one spray nozzle 106 fluidly or pneumatically connected to and located proximal to the pressurized reservoir 104, and at least one actuator 112 coupled to the at least one spray nozzle 106 for controlling pressurized cleaning fluid 107 from the pressurized reservoir 104 to the at least one spray nozzle 106 is provided. Each of the main reservoir 108, the pressurized reservoir 104, the pump 110, the at least one spray nozzle 106, and the at least one actuator 112 are disposed on a vehicle.

To clean the sensor surface 102, the at least one actuator 112 is operated to move the actuator 112 into an open position, enabling pressurized cleaning fluid 107 to flow from the pressurized reservoir 104 to the at least one spray nozzle 106. The pressurized cleaning fluid 07 is then dispensed from the spray nozzle 106 onto the sensor surface 102.

The at least one actuator 112 is then operated to move the at least one actuator 112 into a closed position, preventing the pressurized cleaning fluid 107 from flowing from the pressurized reservoir 104 to the at least one spray nozzle 106.

In some embodiments, the pressurized fluid system 100 includes a timer associated with the at least one actuator 112, and at least one actuator 112 is operated into a closed position after remaining in an open position for a predetermined period of time. In other embodiments, the pressurized fluid system 100 includes a flowmeter associated with the at least one actuator 112, and at least one actuator 112 is operated into a closed position after a predetermined volume of pressurized cleaning fluid 107 is dispensed from the at least one spray nozzle 107.

The pressurized fluid system 100 may then direct compressed air 124a onto the sensor surface 102a, direct compressed air 124b onto the sensor surface 102b in order to expedite drying of the pressurized cleaning solution 107.

What is claimed is:

1. A method for cleaning a sensor surface on a vehicle, the method comprising the steps of:
providing a pressurized fluid system comprising:
a main reservoir disposed on the vehicle, the main reservoir including pressurized cleaning fluid;
a pressurized reservoir disposed on the vehicle and located distal from the main reservoir;
a pump disposed on the vehicle and fluidly connected with the main reservoir for directing pressurized cleaning fluid from the main reservoir to the pressurized reservoir;
at least one spray nozzle disposed on the vehicle adjacent to the sensor surface and located proximal to of the pressurized reservoir; and
at least one actuator coupled to the at least one spray nozzle for controlling flow of pressurized fluid from the pressurized reservoir to the at least one spray nozzle;
operating the at least one actuator into an open position and enable the pressurized cleaning fluid to flow to the at least one spray nozzle;
dispensing the pressurized cleaning fluid from the at least one spray nozzle toward the sensor surface; and
operating the at least one actuator into a closed position and reducing flow of the pressurized cleaning fluid flowing to the at least one spray nozzle.

2. The method of claim 1, wherein the pressurized fluid system further comprises a compressed air source disposed on the vehicle and pneumatically connected to at least one of the at least one actuator, tubing connecting the at least one actuator and the at least one spray nozzle, and wherein the method further comprises the steps of:
directing compressed air from the compressed air source into the pressurized fluid to generated a charged pressurized fluid; and
dispensing the charged pressurized fluid from the at least one spray nozzle toward the sensor surface.

3. The method of claim 1, further comprising the step of:
moving the at least one actuator into a closed position after the at least one actuator was in an open position for a predefined period of time.

4. The method of claim 1 further comprising the step of:
moving the at least one actuator into a closed position after a predefined volume of pressurized cleaning fluid was sprayed from the at least one spray nozzle.
